(19) United States
(12) Patent Application Publication
(10) Pub. No.: US 2024/0249144 A1
(43) Pub. Date: Jul. 25, 2024

(54) USING SHARED AND NON-SHARED PARAMETERS IN AN ATTENTION MODULE-BASED RECOGNITION MODEL

(71) Applicant: Tencent Technology (Shenzhen) Company Limited, Shenzhen (CN)

(72) Inventors: Zhiyuan TANG, Shenzhen (CN); Shen HUANG, Shenzhen (CN); Shidong SHANG, Shenzhen (CN)

(73) Assignee: Tencent Technology (Shenzhen) Company Limited, Shenzhen (CN)

(21) Appl. No.: 18/626,091

(22) Filed: Apr. 3, 2024

Related U.S. Application Data
(63) Continuation of application No. PCT/CN2023/089375, filed on Apr. 20, 2023.

(30) Foreign Application Priority Data
Jun. 21, 2022 (CN) 202210705199.2

(51) Int. Cl. G06N 3/08; G06N 3/04

(52) U.S. Cl. CPC G06N 3/08; G06N 3/04

(57) ABSTRACT

A recognition method includes inputting a media resource feature into a recognition model having N layers of attention modules, and processing the media resource feature by using the N layers of attention modules to obtain a representation vector. An i^{th} layer of attention module is configured to determine an i^{th} layer weight parameter and an i^{th} input representation vector based on (i) a group of shared parameters and (ii) an i^{th} group of non-shared parameters, and determine an i^{th} layer of representation vector outputted by the i^{th} layer of attention module. When i is less than N, the i^{th} layer of representation vector determines an (i+1)^{th} group of non-shared parameters used by an (i+1)^{th} layer of attention module and at least two layers of attention modules among the N layers of attention modules share the group of shared parameters.

### RELATED APPLICATIONS

This application is a continuation of International Application No. PCT/CN2023/089375, filed on Apr. 20, 2023, which claims priority to Chinese Patent Application No. 202210705199.2, filed on Jun. 21, 2022, and entitled “ATTENTION MODULE-BASED INFORMATION RECOGNITION METHOD AND APPARATUS.” The disclosures of the prior applications are hereby incorporated by reference in their entirety.

### FIELD OF THE TECHNOLOGY

This disclosure relates to the field of computers, including attention module-based information recognition.

### BACKGROUND OF THE DISCLOSURE

A self-attention-based recognition model shows great advantages in many tasks, and a self-attention mechanism is an important reason for excellent performance of the self-attention-based recognition model. However, computational complexity of the self-attention mechanism is high, causing low calculation efficiency of the whole recognition model. Sharing attention is a commonly used method for calculation acceleration. At present, common solutions include as follows. A self-attention weight is shared. To be specific, an attention weight of a specific self-attention layer is directly used as an attention weight of another layer, to save computation of the attention weight of another layer.

In a process of using a method of sharing the self-attention weight, because different layers have different degrees of representation abstraction, and the same attention weight is used, serious performance loss of the recognition model is caused, so that a recognition result is difficult to achieve an expected effect.

Therefore, during a recognition process, there is a technical problem in the related art of large performance loss in a recognition module caused by accelerating a computing process by the attention recognition model.

For the foregoing problem, no effective solution has been provided yet.

### SUMMARY

Embodiments of this disclosure provide an attention module-based information recognition method and apparatus, a storage medium, and an electronic device, to at least resolve a technical problem in the related art of large performance loss in a recognition module caused by accelerating a computing process by the attention recognition model.

In an aspect, an attention module-based information recognition method includes inputting a media resource feature of a media resource into a target information recognition model, the target information recognition model including N layers of attention modules, N being a positive integer greater than or equal to 2. The method further includes processing the media resource feature by using the N layers of attention modules to obtain a representation vector, an i^{th} layer of attention module among the N layers of attention modules being configured to determine an i^{th} layer of attention weight parameter and an i^{th} layer of input representation vector based on (i) a group of shared parameters and (ii) an i^{th} group of non-shared parameters, and determine, based on the i^{th} layer of attention weight parameter and the i^{th} layer of input representation vector, an i^{th} layer of representation vector outputted by the i^{th} layer of attention module, where 1≤i≤N. When i is less than N, the i^{th} layer of representation vector determines an (i+1)^{th} group of non-shared parameters used by an (i+1)^{th} layer of attention module. When i is equal to N, the i^{th} layer of representation vector determines the representation vector, where at least two layers of attention modules among the N layers of attention modules share the group of shared parameters. The method further includes determining a target information recognition result based on the representation vector, the target information recognition result representing target information recognized in the media resource.

In an aspect, an attention module-based information recognition apparatus includes processing circuitry configured to input a media resource feature of a media resource into a target information recognition model, the target information recognition model including N layers of attention modules, N being a positive integer greater than or equal to 2. The processing circuitry is further configured to process the media resource feature by using the N layers of attention modules to obtain a representation vector, an i^{th} layer of attention module among the N layers of attention modules being configured to determine an i^{th} layer of attention weight parameter and an i^{th} layer of input representation vector based on (i) a group of shared parameters and (ii) an i^{th} group of non-shared parameters, and determine, based on the i^{th} layer of attention weight parameter and the i^{th} layer of input representation vector, an i^{th} layer of representation vector outputted by the i^{th} layer of attention module, where 1≤i≤N. When i is less than N, the i^{th} layer of representation vector determines an (i+1)^{th} group of non-shared parameters used by an (i+1)^{th} layer of attention module. When i is equal to N, the i^{th} layer of representation vector determines the representation vector, where at least two layers of attention modules among the N layers of attention modules share the group of shared parameters. The processing circuitry is further configured to determine a target information recognition result based on the representation vector, the target information recognition result representing target information recognized in the media resource.

In an aspect, a non-transitory computer-readable storage medium stores computer-readable instructions thereon, which, when executed by processing circuitry, cause the processing circuitry to perform an attention module-based information recognition method that includes inputting a media resource feature of a media resource into a target information recognition model, the target information recognition model including N layers of attention modules, N being a positive integer greater than or equal to 2. The method further includes processing the media resource feature by using the N layers of attention modules to obtain a representation vector, an i^{th} layer of attention module among the N layers of attention modules being configured to determine an i^{th} layer of attention weight parameter and an i^{th} layer of input representation vector based on (i) a group of shared parameters and (ii) an i^{th} group of non-shared parameters, and determine, based on the i^{th} layer of attention weight parameter and the i^{th} layer of input representation vector, an i^{th} layer of representation vector outputted by the i^{th} layer of attention module, where 1≤i≤N. When i is less than N, the i^{th} layer of representation vector determines an (i+1)^{th} group of non-shared parameters used by an (i+1)^{th} layer of attention module. When i is equal to N, the i^{th} layer of representation vector determines the representation vector, where at least two layers of attention modules among the N layers of attention modules share the group of shared parameters. The method further includes determining a target information recognition result based on the representation vector, the target information recognition result representing target information recognized in the media resource.

In the embodiments of this disclosure, a target media resource feature of a target media resource is obtained, and the target media resource feature is inputted into a target information recognition model. The target information recognition model includes N layers of attention modules, and N is a positive integer greater than or equal to 2. The target media resource feature is processed by using the N layers of attention modules to obtain a target representation vector. An i^{th} layer of attention module among the N layers of attention modules is configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module. 1≤i≤N, in a case that i is less than N, the i^{th} layer of representation vector is used for determining an (i+1)^{th} group of non-shared parameters used by an (i+1)^{th} layer of attention module. In a case that i is equal to N, the i^{th} layer of representation vector is used for determining the target representation vector. At least two layers of attention modules among the N layers of attention modules shares the group of shared parameters, and the at least two layers of attention modules includes the i^{th} layer of attention module. A target information recognition result is determined based on the target representation vector. The target information recognition result is used for representing target information recognized from the target media resource. The group of shared parameters and N groups of non-shared parameters are determined, so that the N layers of attention modules may associate each layer of representation vector with a previous layer of non-shared parameters in a process of determining the target representation vector. In this way, an amount of calculation of the attention recognition model is reduced. In addition, excessive loss of the recognition model can be avoided. Therefore, while reducing a quantity of parameters of the recognition model, different layers of self-attention weights are different as needed, so that performance is not lower than or even better than an original recognition model, and technical effects of both model performance and the amount of calculation are considered. Further, a technical problem in the related art of large performance loss in a recognition module caused by accelerating a computing process by the attention recognition model is resolved.

### BRIEF DESCRIPTION OF THE DRAWINGS

FIG. 1 is a schematic diagram of an application environment of an attention module-based information recognition method according to an embodiment of this disclosure.

FIG. 2 is a schematic flowchart of an attention module-based information recognition method according to an embodiment of this disclosure.

FIG. 3 is a schematic diagram of an attention module-based information recognition method according to an embodiment of this disclosure.

FIG. 4 is a schematic diagram of still another attention module-based information recognition method according to an embodiment of this disclosure.

FIG. 5 is a schematic diagram of still another attention module-based information recognition method according to an embodiment of this disclosure.

FIG. 6 is a schematic diagram of still another attention module-based information recognition method according to an embodiment of this disclosure.

FIG. 7 is a schematic diagram of still another attention module-based information recognition method according to an embodiment of this disclosure.

FIG. 8 is a schematic diagram of still another attention module-based information recognition method according to an embodiment of this disclosure.

FIG. 9 is a schematic diagram of a structure of an attention module-based information recognition apparatus according to an embodiment of this disclosure.

FIG. 10 is a schematic diagram of a structure of an attention module-based information recognition product according to an embodiment of this disclosure.

FIG. 11 is a schematic diagram of a structure of an electronic device according to an embodiment of this disclosure.

### DESCRIPTION OF EMBODIMENTS

To make a person skilled in the art better understand the solutions of this disclosure, the following clearly and completely describes the technical solutions in the embodiments of this disclosure with reference to the accompanying drawings in the embodiments of this disclosure. The described embodiments are only some of the embodiments of this application rather than all of the embodiments. All other embodiments obtained by a person of ordinary skill in the art based on the embodiments of this application shall fall within the protection scope of this disclosure.

In this specification, claims, and accompanying drawings of this disclosure, the terms “first”, “second”, and the like are intended to distinguish similar objects but do not necessarily indicate a specific order or sequence. It is to be understood that such used data is interchangeable where appropriate, so that the embodiments of this disclosure described here can be implemented in an order other than those illustrated or described here. Moreover, the terms “include”, “have”, and any other variants are intended to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

First, some terms used in the description of embodiments of this disclosure are explained below.

Attention mechanism: A perception manner and an attention behavior of people is actually applied to a machine, so that the machine learns to perceive important and unimportant parts of data.

Self/Intra-attention mechanism: A weight allocated to each input item depends on an interaction between input items. In other words, which input item is to be paid attention to is determined by “voting” within the input items. An advantage of parallel computing exists during dealing with long input.

This disclosure is described below with reference to the embodiments.

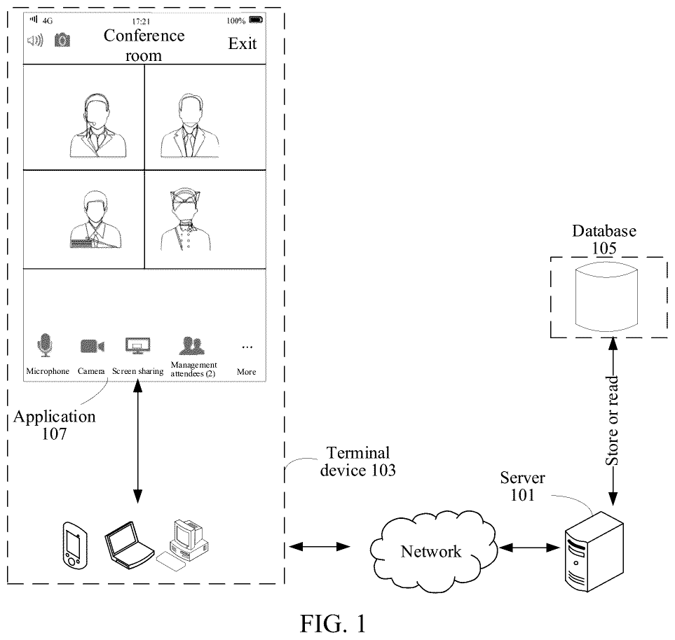

According to an aspect in the embodiments of this disclosure, an attention module-based information recognition method is provided. In this embodiment, the foregoing attention module-based information recognition method may be applied to a hardware environment shown in FIG. 1 including a server 101 and a terminal device 103. As shown in FIG. 1, the server 101 is connected to the terminal device 103 via a network, and may be configured to provide a service for the terminal device or an application that is installed on the terminal device. The application may be a video application, an instant messaging application, a browser application, an educational application, a conference application, or the like. A database 105 may be disposed on the server or independently of the server, and be configured to provide a data storage service for the server 101, such as a voice data storage server. The foregoing network may include, but is not limited to, a wired network and a wireless network. The wired network includes a local area network, a metropolitan area network, and a wide area network. The wireless network includes Bluetooth, Wi-Fi, and another network for wireless communication. The terminal device 103 may be a terminal configured with an application, and may include, but is not limited to, at least one of the following computer devices: a mobile phone (such as an Android phone and an iOS phone), a notebook computer, a tablet computer, a palmtop computer, a mobile Internet device (MID), a desktop computer, a smart television, an intelligent voice interaction device, a smart home appliance, an on-board terminal, an aircraft, and the like. The foregoing server may be a single server, a server cluster including a plurality of servers, or a cloud server. An application 107 using the attention module-based information recognition method is displayed by using the terminal device 103 or another connected display device.

With reference to FIG. 1, the foregoing attention module-based information recognition method may be implemented on the terminal device 103 by using the following steps:

S1: Obtain a target media resource feature of a target media resource on the terminal device 103, and input the target media resource feature into a target information recognition model, the target information recognition model including N layers of attention modules, and N being a positive integer greater than or equal to 2.

S2: Process the target media resource feature by using the N layers of attention modules to obtain a target representation vector on the terminal device 103, an i^{th} layer of attention module among the N layers of attention modules being configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module; 1≤i≤N, in a case that i is less than N, the i^{th} layer of representation vector being used for determining an (i+1)^{th} group of non-shared parameters used by an (i+1)^{th} layer of attention module, and in a case that i is equal to N, the i^{th} layer of representation vector being used for determining the target representation vector; at least two layers of attention modules among the N layers of attention modules sharing the group of shared parameters; and the at least two layers of attention modules including the i^{th} layer of attention module.

S3: Determine a target information recognition result based on the target representation vector on the terminal device 103, the target information recognition result being used for representing target information recognized from the target media resource.

In this embodiment, the foregoing attention module-based information recognition method may alternatively be implemented by a server, for example, by the server 101 shown in FIG. 1, or by a terminal device and a server.

The foregoing description is only an example. This is not specifically limited in this embodiment.

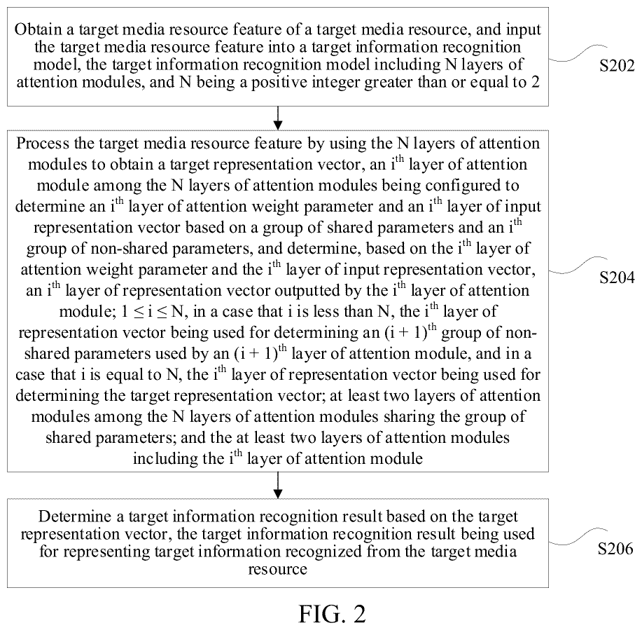

In an embodiment, as an implementation, as shown in FIG. 2, the foregoing attention module-based information recognition method includes:

S202: Obtain a target media resource feature of a target media resource, and input the target media resource feature into a target information recognition model, the target information recognition model including N layers of attention modules, and N being a positive integer greater than or equal to 2. For example, a media resource feature of a media resource is input into a target information recognition model, the target information recognition model including N layers of attention modules, N being a positive integer greater than or equal to 2.

S204: Process the target media resource feature by using the N layers of attention modules to obtain a target representation vector, an i^{th} layer of attention module among the N layers of attention modules being configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module; 1≤i≤N, in a case that i is less than N, the i^{th} layer of representation vector being used for determining an (i+1)th group of non-shared parameters used by an (i+1)^{th} layer of attention module, and in a case that i is equal to N, the i^{th} layer of representation vector being used for determining the target representation vector; at least two layers of attention modules among the N layers of attention modules sharing the group of shared parameters; and the at least two layers of attention modules including the i^{th} layer of attention module. For example, the media resource feature is processed by using the N layers of attention modules to obtain a representation vector. An i^{th} layer of attention module among the N layers of attention modules is configured to determine an i^{th} layer of attention weight parameter and an i^{th} layer of input representation vector based on (i) a group of shared parameters and (ii) an i^{th} group of non-shared parameters. The i^{th} layer of attention module among the N layers of attention modules is further configured to determine, based on the i^{th} layer of attention weight parameter and the i^{th} layer of input representation vector, an i^{th} layer of representation vector outputted by the i^{th} layer of attention module, where 1≤i≤N. When i is less than N, the i^{th} layer of representation vector determines an (i+1)^{th} group of non-shared parameters used by an (i+1)^{th} layer of attention module. When i is equal to N, the i^{th} layer of representation vector determines the representation vector, where at least two layers of attention modules among the N layers of attention modules share the group of shared parameters.

S206: Determine a target information recognition result based on the target representation vector, the target information recognition result being used for representing target information recognized from the target media resource. For example, a target information recognition result is determined based on the representation vector, the target information recognition result representing target information recognized in the media resource.

In the embodiment of this disclosure, the foregoing attention module-based information recognition method may include, but is not limited to, a voice conversation scenario, an emotion recognition scenario, and an image recognition scenario applied to the field of cloud technologies.

A cloud technology is a general term of a network technology, an information technology, an integration technology, a management platform technology, and an application technology based on a cloud computing business model application, and may form a resource pool to satisfy what is needed in a flexible and convenient manner. A cloud computing technology may be the backbone. A lot of computing resources and storage resources are needed for background services in a technical network system, such as a video website, a photo website, and more portal sites. With advanced development and application of the Internet industry, each object is likely to have a recognition flag. These flags need to be transmitted to a background system for logical processing, and data at different levels may be processed separately. Therefore, data processing in all industries requires a strong system to support, and is implemented only through cloud computing technologies.

Cloud computing refers to a delivery and use mode of an IT infrastructure, and refers to obtaining a required resource via a network in an on-demand and scalable manner. Generalized cloud computing refers to a delivery and use mode of a service, and refers to obtaining a required service via a network in an on-demand and scalable manner. This service may be related to IT, software, and Internet, or may be another service. The cloud computing is a product of integration of grid computing, distributed computing, parallel computing, utility computing, a network storage technology, virtualization, load balancing, and another conventional computer and a network technology.

With diversified development of an Internet, a real-time data stream, and a connected device, and demands of a search service, a social network, mobile commerce, and open collaboration, the cloud computing develops rapidly. Different from a previous parallel distributed computing, emergence of the cloud computing promotes a revolutionary change of a whole Internet model and an enterprise management model.

A cloud conference is an efficient, convenient, and low-cost conference form based on a cloud computing technology. A user may share a voice, a data file, and a video with teams and customers all over the world quickly and efficiently by using a simple and easy-to-use operation via an Internet interface, while a cloud conference service providers help for the user with complex technologies such as data transmission and processing in conferences.

Currently, domestic cloud conferences mainly focus on service content with software as a service (SaaS) mode as a main body, including a telephone, a network, a video, and another service form. A video conference based on cloud computing is referred to as a cloud conference.

In the era of the cloud conference, transmission, processing, and storage of data are all processed by a computer resource of a video conference manufacturer. The user does not need to purchase expensive hardware and install cumbersome software at all, just open a browser and log in to a corresponding interface, so that an efficient remote conference can be performed.

The cloud conference system supports multi-server dynamic cluster deployment and provides a plurality of high-performance servers, to greatly improve stability, security, and availability of a conference. In recent years, the video conference is widely used in various fields, such as transportation, transmission, finance, operators, education, and enterprises because the video conference can greatly improve communication efficiency, continuously reduce communication costs, and upgrade an internal management level. Undoubtedly, after the video conference uses the cloud computing, it is more attractive in terms of convenience, rapidity, and ease of use, to surely stimulate arrival of a new climax of video conference application.

In the embodiment of this disclosure, for example, in the foregoing cloud conference scenario, it may include, but is not limited to, that automatic conference minutes in the conference is implemented by using an end-to-end voice recognition model structure via the artificial intelligence cloud service.

The artificial intelligence cloud service is also generally referred to as AI as a service (AIaaS). This is a mainstream service mode of an artificial intelligence platform at present. Specifically, an AiaaS platform splits several common AI services and provides independent or packaged services in the cloud. This service mode is similar to opening an AI theme store. All developers can access and use one or more artificial intelligence services provided by a platform via an API interface. Some experienced developers may alternatively use an AI framework and an AI infrastructure provided by the platform to deploy and operate their own exclusive cloud artificial intelligence services.

Artificial intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, the artificial intelligence is a comprehensive technology in computer science and attempts to understand the essence of intelligence and produce a new intelligent machine that can react in a manner similar to human intelligence. The artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. The basic artificial intelligence technologies generally include technologies such as a sensor, a dedicated AI chip, cloud computing, distributed storage, a big data processing technology, an operating/interaction system, and electromechanical integration. The artificial intelligence software technologies mainly include several major directions such as a computer vision (CV) technology, a speech processing technology, a natural language processing technology, and machine learning/deep learning. A key technology of a speech technology includes an automatic speech recognition (ASR) technology, a text to speech (TTS) technology, and a voiceprint recognition technology. It is a development direction of human-computer interaction in the future that a computer can listen, see, speak, and feel. A voice becomes one of the most promising manners of human-computer interaction in the future.

For example, the foregoing attention module-based information recognition method may be, but is not limited to, applied to application scenarios based on artificial intelligence, such as remote training, remote consultation, an emergency command, a remote interview, an open class, remote medical, and business negotiation.

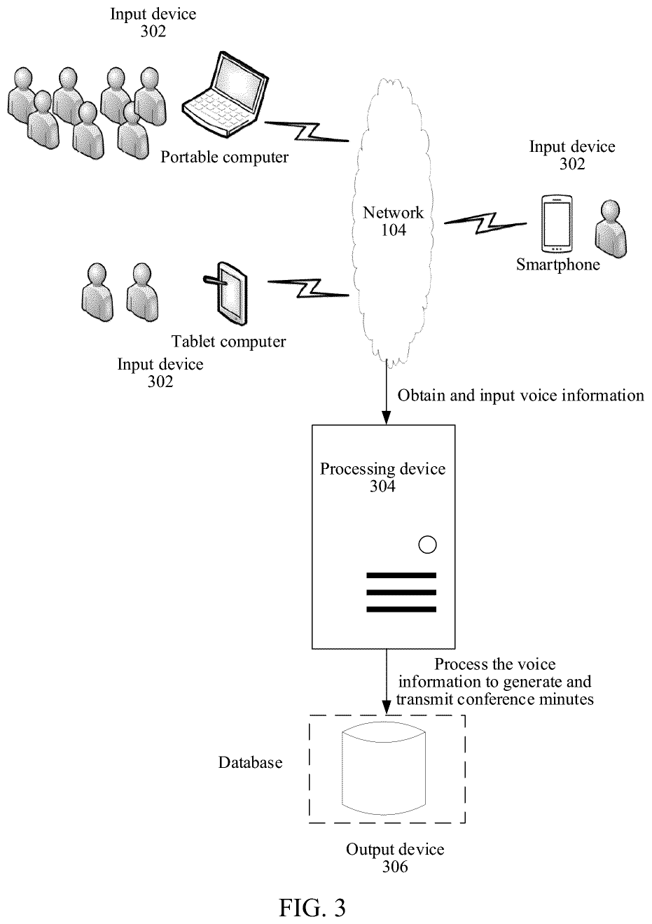

In an embodiment of this disclosure, FIG. 3 is a schematic diagram of an attention module-based information recognition method according to an embodiment of this disclosure. As shown in FIG. 3, an example in which the method is applied to a cloud conference scenario is used. An input device 302, a processing device 304, and an output device 306 are included. The input device 302 is configured to obtain voice information sent by an account participating in the cloud conference. The voice information may be obtained, but is not limited to, by a microphone or another voice input device. After the voice information is obtained, the voice information is inputted into the processing device 304 of a cloud server. The processing device 304 may include, but is not limited to, a neural network model formed by a universal Conformer/Transformer-based on neural network structure. The voice information is inputted into the neural network model to obtain a representation vector outputted by the neural network model, and then the representation vector is processed to obtain a final recognition result. The final recognition result is recorded in a database by the output device 306 and stored in the server as the automatic conference minutes.

The target media resource may include, but is not limited to, the voice information collected in the cloud conference scenario. A target representation vector may be understood as a representation vector that can represent the voice information. The target representation vector is inputted into the processing device 304 in the cloud conference to determine the recognition result.

For example, the group of shared parameters may include, but is not limited to, parameters W^{Q}, W^{K}, and W^{V} used in an attention mechanism. In a cloud conference application scenario, the foregoing parameters are used for adjusting in training the foregoing text recognition model (corresponding to the foregoing target recognition model) to determine attention weight parameters based on the attention mechanism. In a case that the text recognition model is used to recognize features corresponding to the voice information, the group of shared parameters are controlled to remain unchanged and applied to each layer of attention module among the N layers of attention modules.

In the cloud conference scenario, the i^{th} group of non-shared parameters may be understood that each layer of attention module among the N layers of attention modules is independently configured, including, but is not limited to, an (i−1)^{th} intermediate layer of voice representation parameter Hᵢ₋₁, and further includes, but is not limited to, an original voice feature or a voice representation parameter obtained via several layers of simple neural networks.

The i^{th} layer of attention weight parameter may include, but is not limited to, an attention weight parameter Aᵢ of an i^{th} layer of voice feature obtained by performing a normalization operation on Qᵢ and Kᵢ. The i^{th} layer of input representation vector may include, but is not limited to, a voice feature Vi. An i^{th} layer of voice representation vector Gᵢ=A′ᵢVᵢ outputted by the i^{th} layer of attention module is determined based on the i^{th} layer of attention weight parameter and the i^{th} layer of input representation vector.

Gᵢ is a voice representation vector that needs to be inputted to a next layer of attention module. Gᵢ is used for determining an (i+1)^{th} intermediate layer of voice representation parameter Hᵢ, and further determining Gᵢ₊₁ by using the foregoing steps, and so on, until G_{N} outputted by the last layer of attention module is determined to be used for a downstream voice recognition task to obtain a voice recognition result.

In the cloud conference scenario, at least two layers of attention modules among the N layers of attention modules share a group of shared parameters. The group of shared parameters may include, but is not limited to, the to-be-learned voice recognition parameters: W^{Q}, W^{K}, and W^{V}.

For example, in a Transformer-based end-to-end voice recognition model structure, an encoder may also use Conformer to share a unified multi-head attention calculation module (to share W^{Q}, W^{K}, and W^{V}, corresponding to the foregoing group of shared parameters) by using a multi-head attention module (corresponding to the foregoing attention module) of an Ne layer Transformer in the encoder. The encoder includes Ne attention modules, and a decoder includes an encoder including Na attention modules. A voice resource is inputted from Inputs. The foregoing voice feature is obtained after the voice resource is processed by Concv/2+ReLU and Additional Module twice. The voice feature is inputted into Encoding, and the voice feature is processed by the N layers of attention modules (the multi-head attention) to obtain a voice representation vector G_{N} and generate a voice recognition result. Alternatively, G_{N} is inputted into the decoder to obtain a voice recognition result.

The foregoing description is only an example. This is not specifically limited in the embodiment of this disclosure.

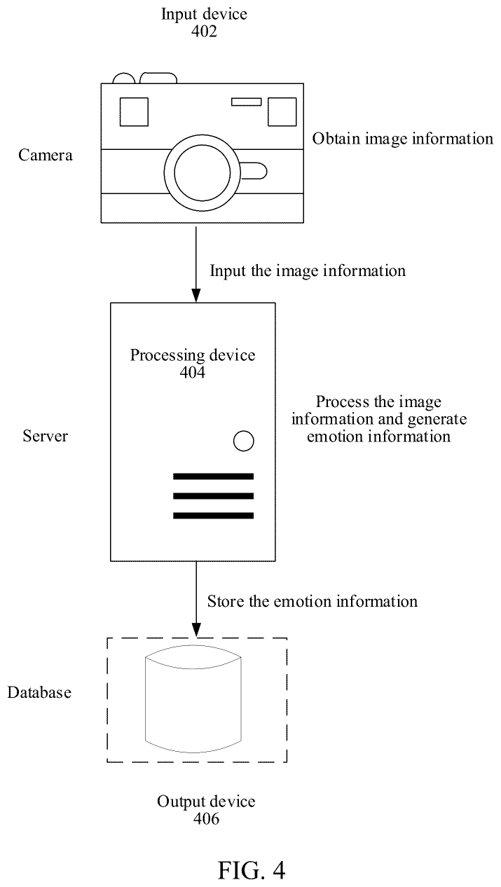

In an embodiment of this disclosure, FIG. 4 is a schematic diagram of another attention module-based information recognition method according to an embodiment of this disclosure. As shown in FIG. 4, an example in which the method is applied to an emotion recognition scenario is used. An input device 402, a processing device 404, and an output device 406 are included. The input device 402 is configured to obtain image information capable of expressing an emotion. After image information is obtained, the image information is inputted into the processing device 404 of the cloud server. The foregoing processing device 404 may include, but is not limited to, a neural network model formed by a neural network structure. The image information is inputted into the neural network model to obtain a representation vector outputted by the neural network model. Then, the representation vector is processed to obtain a final recognition result. The final recognition result is further processed by using the output device 406 to store recognized emotion information in a database.

The target media resource may include, but is not limited to, the image information collected in the emotion recognition scenario. A target representation vector may be understood as a representation vector that can represent the image information. The target representation vector is inputted into the processing device 304 in emotion recognition to determine the recognition result.

For example, the group of shared parameters may include, but is not limited to, parameters W^{Q}, W^{K}, and W^{V} used in an attention mechanism. In an emotion recognition application scenario, the foregoing parameters are used for adjusting in training the foregoing text recognition model (corresponding to the foregoing target recognition model) to determine attention weight parameters based on the attention mechanism. In a case that the text recognition model is used to recognize features corresponding to the image information, the group of shared parameters are controlled to remain unchanged and applied to each layer of attention module among the N layers of attention modules.

In the emotion recognition scenario, the i^{th} group of non-shared parameters may be understood that each layer of attention module among the N layers of attention modules is independently configured, includes, but is not limited to, an (i−1)^{th} intermediate layer of image representation parameter Hᵢ₋₁, and further includes, but is not limited to, an original image feature or an image representation parameter obtained via several layers of simple neural networks.

The i^{th} layer of attention weight parameter may include, but is not limited to, an attention weight parameter Aᵢ of an i^{th} layer of image feature obtained by performing a normalization operation on Q; and Ki. The i^{th} layer of input representation vector may include, but is not limited to, an image feature Vi. An i^{th} layer of image representation vector Gᵢ=A′ᵢVᵢ outputted by the i^{th} layer of attention module is determined based on the i^{th} layer of attention weight parameter and the i^{th} layer of input representation vector.

Gᵢ is an image representation vector that needs to be inputted to a next layer of attention module. Gᵢ is used for determining an (i+1)^{th} intermediate layer of image representation parameter Hᵢ, and further determining Gᵢ₊₁ by using the foregoing steps, and so on, until G_{N} outputted by the last layer of attention module is determined to be used for a downstream image recognition task to obtain an image recognition result.

In the emotion recognition scenario, at least two layers of attention modules among the N layers of attention modules share a group of shared parameters. The group of shared parameters may include, but is not limited to, the to-be-learned image recognition parameters: W^{Q}, W^{K}, and W^{V}.

For example, in a Transformer-based end-to-end image recognition model structure, an encoder may also use Conformer, to share a unified multi-head attention calculation module (to share W^{Q}, W^{K}, and W^{V}, corresponding to the foregoing group of shared parameters) by using a multi-head attention module (corresponding to the foregoing attention module) of an Nₑ layer of Transformer in the encoder. The encoder includes Ne attention modules, and a decoder includes an encoder including N_{d} attention modules. An image resource is inputted from Inputs. The foregoing image feature is obtained after the image resource is processed by Concv/2+ReLU and Additional Module twice. The image feature is inputted into Encoding, and the image feature is processed by the N layers of attention modules (the multi-head attention) to obtain an image representation vector G_{N} and generate an image recognition result. Alternatively, G_{N} is inputted into the decoder to obtain an image recognition result.

The foregoing description is only an example. This is not specifically limited in the embodiment of this disclosure.

The foregoing attention module-based information recognition method may be further applied to a processing device that has a limited computing resource and memory and cannot support a large amount of calculation, such as a mobile phone, a speaker, a small household appliance, and an embedded product. The processing device is configured to recognize voice or image information, to use a recognized text, an emotional type, an object, an action, and the like to a downstream scenario.

In the embodiment of this disclosure, the foregoing target media resource may include, but is not limited to, a media resource, such as a to-be-recognized video, audio, and picture. Specifically, the media resource may include, but is not limited to, voice information collected in the cloud conference scenario, video information played in an advertisement, a to-be-recognized picture collected in a security field, and the like.

In the embodiment of this disclosure, the foregoing target media resource feature may include, but is not limited to, a media resource feature extracted from a conventional neural network model for inputting the target media resource, and may be expressed, but is not limited to, in a form of a vector.

In the embodiment of this disclosure, the target information recognition model may include, but is not limited to, a multi-layer of attention modules. The N layers of attention modules may use, but are not limited to, a unified attention calculation module to complete a calculation task. The target information recognition model may include, but is not limited to, a Transformer-based end-to-end voice recognition model structure. The encoder may also use Conformer.

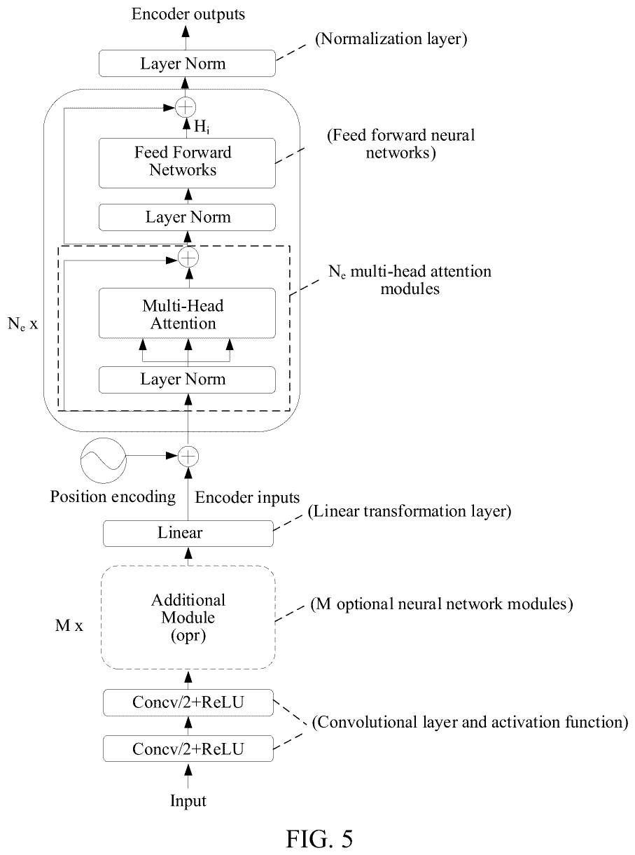

For example, FIG. 5 is a schematic diagram of a still another attention module-based information recognition method according to an embodiment of this disclosure. As shown in FIG. 5, the foregoing Transformer-based end-to-end voice recognition model structure is formed by Ne attention modules.

In the embodiment of this disclosure, the target representation vector may be understood as a representation vector that can represent the target media resource. The target representation vector is inputted into the subsequent processing model to determine the recognition result, so that data, such as a text, needed by a service is generated.

In the embodiment of this disclosure, the group of shared parameters may include, but is not limited to, parameters W^{Q}, W^{K}, and W^{V} used in an attention mechanism. The foregoing parameters are used for adjusting in the target information recognition model to determine attention weight parameters based on the attention mechanism. In a case that the target information recognition model is used to recognize the target media resource feature, the group of shared parameters are controlled to remain unchanged and applied to each layer of attention module among the N layers of attention modules.

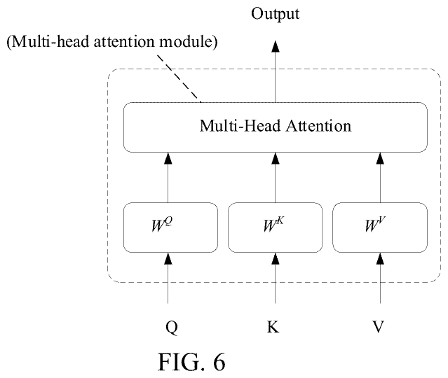

For example, FIG. 6 is a schematic diagram of a still another attention module-based information recognition method according to an embodiment of this disclosure. As shown in FIG. 6, each layer of attention module (Multi-Head Attention) inputs Q, K, and V that are associated with W^{Q}, W^{K}, and W^{V} respectively, and then a representation vector of this layer is obtained.

In the embodiment of this disclosure, the i^{th} group of non-shared parameters may be understood that each layer of attention module among the N layers of attention modules is independently configured, may include, but is not limited to, an (i−1)^{th} intermediate layer of representation parameter Hᵢ₋₁, and further includes, but is not limited to, an original feature or a representation parameter obtained via several layers of simple neural networks.

In the embodiment of this disclosure, the i^{th} layer of attention weight parameter may include, but is not limited to, an i^{th} layer of attention weight parameter Aᵢ obtained by performing a normalization operation on Q; and Ki. The i^{th} layer of input representation vector may include, but is not limited to, Vi. An i^{th} layer of representation vector Gᵢ=A′ᵢVᵢ outputted by the i^{th} layer of attention module is determined based on the i^{th} layer of attention weight parameter and the i^{th} layer of input representation vector.

Gᵢ is a representation vector that needs to be inputted to a next layer of attention module. Gᵢ is used for determining an (i+1)^{th} intermediate layer of representation parameter Hᵢ, and further determining Gᵢ₊₁ by using the foregoing steps, and so on, until G_{N} outputted by the last layer of attention module is determined to be used for a downstream recognition task to obtain a target information recognition result.

In other words, in a case that i is less than N, the i^{th} layer of representation vector is used for determining an (i+1)^{th} group of non-shared parameters used by the (i+1)^{th} layer of attention module. In a case that i is equal to N, that the i^{th} layer of representation vector is used for determining the target representation vector may be understood that Gᵢ is used for determining Hᵢ in a case that i<N in Gᵢ, and Gᵢ is used for determining G_{N} in a case that i=N in Gᵢ.

In the embodiment of this disclosure, at least two layers of attention modules among the N layers of attention modules share a group of shared parameters. The group of shared parameters may include, but is not limited to, W^{Q}, W^{K}, and W^{V}. In other words, W^{Q}, W^{K}, and W^{V} among the N layers of attention modules may be configured with a plurality of groups as shared parameters, may be configured with one group as shared parameters.

In the embodiment of this disclosure, the determining a target information recognition result based on the target representation vector may include, but is not limited to, directly generating the target information recognition result based on the target representation vector outputted by the encoder including the N layers of attention modules, and may alternatively include, but is not limited to, inputting the representation vector outputted by the encoder including the N layers of attention modules into the decoder to generate the target information recognition result by using N layers of mask modules and the N layers of attention modules of the decoder.

In the embodiment of this disclosure, the target information recognition result represents target information recognized from the target media resource, and may include, but is not limited to, semantic information included in the target media resource, emotion type information included in the target media resource, and the like.

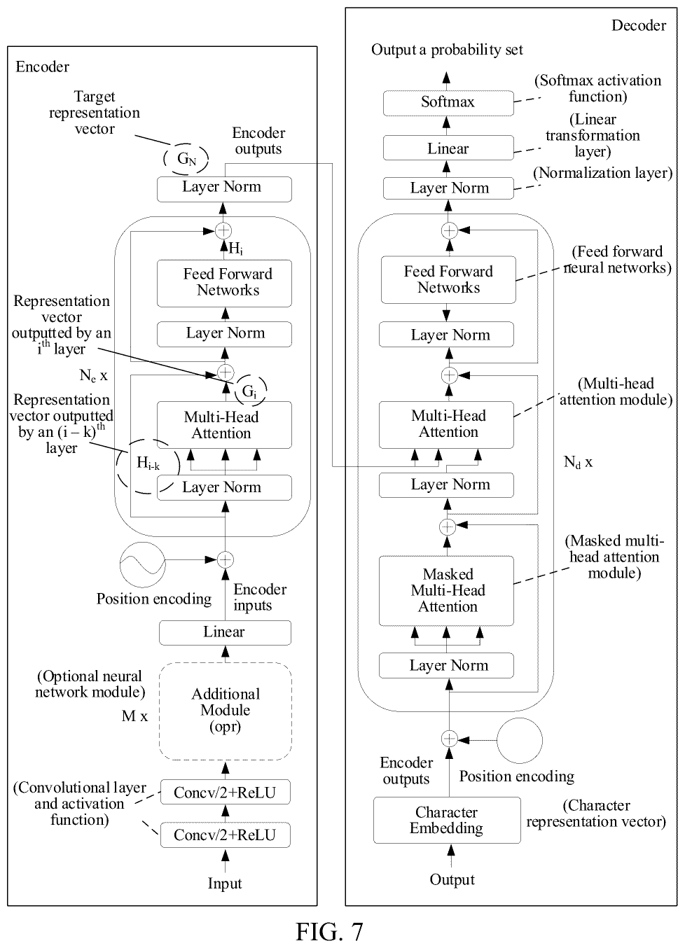

For example, FIG. 7 is a schematic diagram of a still another attention module-based information recognition method according to an embodiment of this disclosure. As shown in FIG. 7, a Transformer-based end-to-end voice recognition model structure is included. An encoder may also use Conformer, to share a unified multi-head attention calculation module (to share W^{Q}, W^{K}, and W^{V}, corresponding to the foregoing group of shared parameters) by using a multi-head attention module (corresponding to the foregoing attention module) of an Ne layer of Transformer in the encoder. Similarly, both the multi-headed attention module and a masked multi-head attention module in a decoder section on the right in FIG. 7 may separately share a group of modules (share W^{Q}, W^{K}, and W^{V}).

The encoder includes Ne attention modules, and a decoder includes an encoder including Na attention modules. A target media resource is inputted from the encoder. The foregoing target media resource feature is obtained after the target media resource is processed by Concv/2+ReLU (a convolutional layer and an activation function) and Additional Module twice. The target media resource feature is inputted into Encoding, and the target media resource feature is processed by the N layers of attention modules (the multi-head attention) to obtain a target representation vector G_{N} and generate a target information recognition result. Alternatively, G_{N} is inputted into the decoder to obtain a target information recognition result.

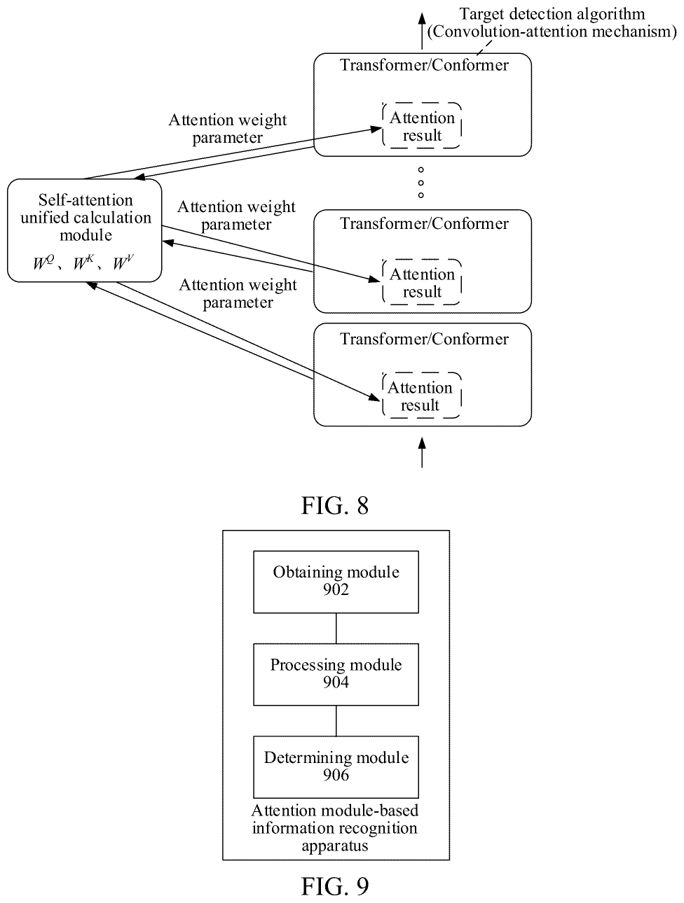

For example, FIG. 8 is a schematic diagram of a still another attention module-based information recognition method according to an embodiment of this disclosure. As shown in FIG. 8, the foregoing group of shared parameters may be, but is not limited to, implemented by using a self-attention unified calculation module. W^{Q}, W^{K}, and W^{V} are stored in the module, so that the foregoing parameters may be used to separately calculate each layer of attention weight parameter.

In the embodiments of this disclosure, a target media resource feature of a target media resource is obtained, and the target media resource feature is inputted into a target information recognition model. The target information recognition model includes N layers of attention modules, and N is a positive integer greater than or equal to 2. The target media resource feature is processed by using the N layers of attention modules to obtain a target representation vector. An i^{th} layer of attention module among the N layers of attention modules is configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module. 1≤i≤N, in a case that i is less than N, the i^{th} layer of representation vector is used for determining an (i+1)^{th} group of non-shared parameters used by an (i+1)^{th} layer of attention module. In a case that i is equal to N, the i^{th} layer of representation vector is used for determining the target representation vector. The target media resource feature is used for determining a first group of non-shared parameters used in a first layer of attention module among the N layers of attention modules. At least two layers of attention modules among the N layers of attention modules share the group of shared parameters. The at least two layers of attention modules includes the i^{th} layer of attention module. A target information recognition result is determined based on the target representation vector. The target information recognition result is used for representing target information recognized from the target media resource. The group of shared parameters and N groups of non-shared parameters are determined, so that the N layers of attention modules may associate each layer of representation vector with a previous layer of non-shared parameters in a process of determining the target representation vector. In this way, an amount of calculation of the attention recognition model is reduced. In addition, excessive loss of the recognition model can be avoided. Therefore, while reducing a quantity of parameters of the recognition model, different layers of self-attention weights are different as needed, so that performance is not lower than or even better than an original recognition model, and technical effects of both model performance and the amount of calculation are considered. Further, a technical problem in the related art of large performance loss in a recognition module caused by accelerating a computing process by the attention recognition model is resolved.

As an solution, in a case that i is greater than 1, the i^{th} layer of attention weight parameter and the i^{th} layer of input representation vector are determined by using the following manners:
determining the i^{th} layer of attention weight parameter based on a first part of shared parameters and an (i−1)^{th} intermediate layer of representation parameter, the group of shared parameters including the first part of shared parameters and a second part of shared parameters, and the (i−1)^{th} intermediate layer of representation parameter being an intermediate layer of representation parameter determined based on an (i−1)^{th} layer of representation vector outputted by an (i−1)^{th} layer of attention module;
determining the i^{th} layer of input representation vector based on the second part of shared parameters and the (i−1)^{th} intermediate layer of representation parameter, the i^{th} group of non-shared parameters including the (i−1)^{th} intermediate layer of representation parameter; and
performing weighted summation on the i^{th} layer of attention weight parameter and the i^{th} layer of input representation vector to obtain the i^{th} layer of representation vector outputted by the i^{th} layer of attention module.

In the embodiment of this disclosure, the foregoing first part of shared parameters may be understood as W^{Q}, W^{K}. The foregoing (i−1)^{th} intermediate layer of representation parameters may be understood as Gᵢ₋₁ outputted by the upper layer outputs Hᵢ₋₁ through a feed forward neural network. Hᵢ₋₁ is determined by Gᵢ₋₁. For multi-head attention: Input is H and a previous layer of attention value A′ᵢ. Output is G. A, is the i^{th} layer of attention weight parameter determined by W^{Q}, W^{K}, and W^{V}. G passes through the feed forward network to obtain H.

In the embodiment of this disclosure, the foregoing i^{th} layer of attention weight parameter may include, but is not limited to, A′ᵢ. Selective manners of Aᵢ=Softmax(QK^{T}/\sqrt{dₖ}), A′ᵢ=ƒ(Aᵢ, A′ᵢ₋₁), and ƒ are flexible, such as ƒ (Aᵢ, A′ᵢ₋₁)=(1-α)Aᵢ+αA′ᵢ₋₁, 0≤α≤1.

In the embodiment of this disclosure, the foregoing second part of shared parameters may be understood as W^{V}. The foregoing i^{th} layer of input representation vector may be understood as Vᵢ that is an intermediate layer of representation determined based on a representation feature inputted by the upper layer, Gᵢ=A′ᵢVᵢ.

As a solution, the determining the i^{th} layer of attention weight parameter based on a first part of shared parameters and an (i−1)^{th} intermediate layer of representation parameter includes:
separately multiplying, in a case that the first part of shared parameters includes a first shared parameter W^{Q} and a second shared parameter W^{K}, and the (i−1)^{th} intermediate layer of representation parameter is Hᵢ₋₁, Hᵢ₋₁ by W^{Q} and W^{K} to obtain a first correlation parameter Qᵢ and a second correlation parameter Kᵢ used in the i^{th} layer of attention module;
performing normalization processing on the first correlation parameter Qᵢ and the second correlation parameter Ki to obtain an initial attention weight parameter Aᵢ of the i^{th} layer of attention module; and
determining the i^{th} layer of attention weight parameter based on the initial attention weight parameter Aᵢ and an (i−1)^{th} layer of attention weight parameter A′ᵢ₋₁ that is used in the (i−1)^{th} layer of attention module.

In the embodiment of this disclosure, Hᵢ₋₁ is separately multiplied, in a case that the first part of shared parameters includes a first shared parameter W^{Q} and a second shared parameter W^{K}, and the (i−1)^{th} intermediate layer of representation parameter is Hᵢ₋₁, by W^{Q} and W^{K} to obtain a first correlation parameter Qᵢ and a second correlation parameter Kᵢ used in the i^{th} layer of attention module, which may include, but is not limited to, the following formula. W^{Q} and W^{K} are both in the form of a matrix:

$$\begin{matrix}{Q}_{i} = {H}_{i - 1} {W}^{Q} \\ {K}_{i} = {H}_{i - 1} {W}^{K}\end{matrix}$$

In the embodiment of this disclosure, normalization processing is performed on the first correlation parameter Qᵢ and the second correlation parameter Kᵢ to obtain an initial attention weight parameter Aᵢ of the i^{th} layer of attention module.

$${A}_{i} = Softmax ( {Q}_{i} {K}_{i}^{T} / \sqrt{{d}_{k}} )$$

All Qᵢ, Kᵢ, and Aᵢ are intermediate calculation results. d_{K} indicates a length of K.

As a solution, the determining the i^{th} layer of attention weight parameter based on the initial attention weight parameter Aᵢ and an (i−1)^{th} layer of attention weight parameter A′ᵢ₋₁ that is used in the (i−1)^{th} layer of attention module includes:
performing weighted summation on the initial attention weight parameter Aᵢ and the (i−1)^{th} layer of attention weight parameter A′ᵢ₋₁ to obtain the i^{th} layer of attention weight parameter.

In the embodiment of this disclosure, the determining the i^{th} layer of attention weight parameter based on the initial attention weight parameter Aᵢ and an (i−1)^{th} layer of attention weight parameter A′ᵢ₋₁ that is used in the (i−1)^{th} layer of attention module may include, but is not limited to, the following formula:

$${A}_{i}^{′} = f ( {A}_{i} , {A}_{i - 1}^{′} )$$

A selective manner of ƒ is flexible, such as ƒ (Aᵢ, A′ᵢ₋₁)=(1-α)Aᵢ+αA′ᵢ₋₁, 0≤α≤1. In a case that α=1, ƒ is a conventional self-attention weight sharing mode. In other words, a weight value is shared instead of a to-be-learned parameter W^{Q}, W^{K}, and W^{V} for computing the weight value. In a case that α=0, ƒ does not depend on a previous layer of self-attention weight. ƒ may be another neural network with any complexity.

As a solution, in a case that the at least two layers of attention modules further includes the (i+1)^{th} layer of attention module, an (i+1)^{th} layer of attention weight parameter and an (i+1)^{th} layer of input representation vector of the (i+1)^{th} layer of attention module are determined by using the following manners:
determining the (i+1)^{th} layer of attention weight parameter based on the first part of shared parameters and an i^{th} intermediate layer of representation parameter, the i^{th} intermediate layer of representation parameter being an intermediate layer of representation parameter determined based on the i^{th} layer of representation vector outputted by the i^{th} layer of attention module;
determining the (i+1)^{th} layer of input representation vector based on the second part of shared parameters and the i^{th} intermediate layer of representation parameter, the (i+1)^{th} group of non-shared parameters including the i^{th} intermediate layer of representation parameter; and
performing weighted summation on the (i+1)^{th} layer of attention weight parameter and the (i+1)^{th} layer of input representation vector to obtain the (i+1)^{th} layer of representation vector outputted by the (i+1)^{th} layer of attention module.

In the embodiment of this disclosure, the (i+1)^{th} layer of attention module may separately determine the (i+1)^{th} layer of attention weight parameter A′ᵢ₊₁ and the (i+1)^{th} layer of input representation vector Viti by using the same manner of first part of shared parameters and the second part of shared parameters as the i^{th} layer of attention module.

In other words, in the embodiment of this disclosure, each layer of attention module uses a shared attention parameter (W^{Q}, W^{K}, and W^{V}) to perform feature processing to obtain the layer of representation vector.

As a solution, the i^{th} layer of attention weight parameter and the i^{th} layer of input representation vector are determined by using the following manners:
determining the i^{th} layer of attention weight parameter based on a shared attention weight parameter and a weighting parameter that is used in the i^{th} layer of attention module, the group of shared parameters including the shared attention weight parameter and a second part of shared parameters;
determining the i^{th} layer of input representation vector based on the second part of shared parameters and an (i−1)^{th} intermediate layer of representation parameter, the (i−1)^{th} intermediate layer of representation parameter being an intermediate layer of representation parameter determined based on an (i−1)^{th} layer of representation vector outputted by an (i−1)^{th} layer of attention module, and the i^{th} group of non-shared parameters including the (i−1)^{th} intermediate layer of representation parameter; and
performing weighted summation on the i^{th} layer of attention weight parameter and the i^{th} layer of input representation vector to obtain the i^{th} layer of representation vector outputted by the i^{th} layer of attention module.

In the embodiment of this disclosure, the shared attention weight parameter may be understood as A. The weighting parameter used in the foregoing i^{th} layer of attention module may include, but is not limited to, pre-configured W ¿. In this way, the foregoing i^{th} layer of attention weight parameter is determined by the following formula:

$${A}_{i} = {f}_{i} ( A )$$

A function ƒ allows different layers to obtain different final attention weights Aᵢ based on the same initial attention value A.

In the embodiment of this disclosure, the i^{th} layer of input representation vector is determined by using the following formula:

$${V}_{i} = {H}_{i - 1} {W}^{V}$$

The (i−1)^{th} intermediate layer of representation parameter is an intermediate layer of representation parameter determined based on the (i−1)^{th} layer of representation vector outputted by the (i−1)^{th} layer of attention module. The i^{th} group of non-shared parameters includes the (i−1)^{th} intermediate layer of representation parameter, and Gᵢ=AᵢVᵢ.

As a solution, the determining the i^{th} layer of attention weight parameter based on a shared attention weight parameter and a weighting parameter that is used in the i^{th} layer of attention module includes:

determining a sum of the shared attention weight parameter and the weighting parameter that is used in the i^{th} layer of attention module as the i^{th} layer of attention weight parameter.

For example, a selective manner of ƒ is flexible. For example, a sum of the shared attention weight parameter and the weighting parameter that is used in the i^{th} layer of attention module is determined as the i^{th} layer of attention weight parameter, that is, ƒᵢ(A)=A+Wᵢ.

As a solution, the method further includes:
obtaining an initial representation feature of the target media resource, the initial representation feature being the target media resource feature, or a feature converted based on the target media resource feature;
separately multiplying, in a case that the group of shared parameters further includes a first part of shared parameters, and the first part of shared parameters includes a first shared parameter W^{Q} and a second shared parameter W^{K}, the initial representation feature by W^{Q} and W^{K} to obtain a first shared correlation parameter Q and a second shared correlation parameter K; and
performing normalization processing on the first shared correlation parameter Q and the second shared correlation parameter K to obtain the shared attention weight parameter.

In the embodiment of this disclosure, the foregoing initial representation feature may include, but is not limited to, the target media resource feature or a feature obtained by converting the target media resource feature inputted into another neural network model.

In the embodiment of this disclosure, the performing normalization processing on the first shared correlation parameter Q and the second shared correlation parameter K to obtain the shared attention weight parameter may include, but is not limited, the following formula:

$${A}_{i} = Softmax ( {QK}^{T} / \sqrt{{d}_{k}} )$$

Aᵢ represents the shared attention weight parameter. d_{K} represents a length of K.

As a solution, in a case that the at least two layers of attention modules further includes the (i+1)^{th} layer of attention module, an (i+1)^{th} layer of attention weight parameter and an (i+1)^{th} layer of input representation vector of the (i+1)^{th} layer of attention module are determined by using the following manners:
determining an (i+1)^{th} layer of attention weight parameter based on the shared attention weight parameter and a weighting parameter that is used in the (i+1)^{th} layer of attention module;
determining the (i+1)^{th} layer of input representation vector based on the second part of shared parameters and an i^{th} intermediate layer of representation parameter, the i^{th} intermediate layer of representation parameter being an intermediate layer of representation parameter determined based on the i^{th} layer of representation vector outputted by the i^{th} layer of attention module, and the (i+1)^{th} group of non-shared parameters including the i^{th} intermediate layer of representation parameter; and
performing weighted summation on the (i+1)^{th} layer of attention weight parameter and the (i+1)^{th} layer of input representation vector to obtain the (i+1)^{th} layer of representation vector outputted by the (i+1)^{th} layer of attention module.

In the embodiment of this disclosure, the foregoing shared attention weight parameter may be understood as A. The weighting parameter used in the foregoing (i+1)^{th} layer of attention module may be understood as Wᵢ. The foregoing (i+1)^{th} layer of attention weight parameter may be understood as Aᵢ. The foregoing second part of the shared parameters may be understood as W^{V}. The foregoing i^{th} intermediate layer of representation parameter may be understood as Hᵢ₋₁. The foregoing (i+1)^{th} layer of input representation vector may be understood as Vᵢ. The foregoing (i+1) layer of representation vector may be understood as Gᵢ.

In other words, the above may be, but is not limited to, determined by the following formula:

$$\begin{matrix}{Q}_{i} = {H}_{i - 1} {W}^{Q} \\ {K}_{i} = {H}_{i - 1} {W}^{K} \\ {A}_{i} = Softmax ( {Q}_{i} {K}_{i}^{T} / \sqrt{{d}_{k}} ) \\ {A}_{i}^{′} = f ( {A}_{i} , {A}_{i - 1}^{′} ) \\ {G}_{i} = {A}_{i}^{′} {V}_{i}\end{matrix}$$

H represents input of an attention module. W^{Q}, W^{K}, and W^{V} represent to-be-learned parameters and are in a matrix form. All Q, K, V, and A are intermediate calculation Results. d_{K} represents a length of K. A′ᵢ is a self-attention value of an i^{th} layer of Transformer. ƒ is a user-defined function. G is result output of a self-attention module. Different layers of attention modules of Transformer in the encoder share W^{Q}, W^{K}, and W^{V}. The function ƒ refers to a previous layer of result in a case that a current layer of attention is calculated. A selection manner of ƒ is flexible, such as ƒ (Aᵢ, A′ᵢ₋₁)=(1−α) Aᵢ+αA′ᵢ₋₁, 0≤α≤1. ƒ may be another neural network with any complexity.

As a solution, the determining the i^{th} layer of input representation vector based on the second part of shared parameters and an (i−1)^{th} intermediate layer of representation parameter includes:
multiplying, in a case that the second part of shared parameters includes a third shared parameter W^{V}, and the (i−1)^{th} intermediate layer of representation parameter is Hᵢ₋₁, Hᵢ₋₁ by W^{V} to obtain the i^{th} layer of input representation vector.

In the embodiment of this disclosure, the i^{th} layer of input representation vector may be, but is not limited to, determined by the following formula:

$${V}_{i} = {H}_{i - 1} {W}^{V}$$

As a solution, the foregoing method further includes:
obtaining an (i−k)^{th} intermediate layer of representation parameter in a case that the (i−1)^{th} layer of representation vector outputted by the (i−1)^{th} layer of attention module is obtained, 1<k<i, and the (i−k)^{th} intermediate layer of representation parameter being an intermediate layer of representation parameter determined based on the (i−k)^{th} layer of representation vector outputted by the (i−k)^{th} layer of attention module; and
determining the (i−1)^{th} intermediate layer of representation parameter based on the (i−1)^{th} layer of representation vector and the (i−k)^{th} intermediate layer of representation parameter.

In the embodiment of this disclosure, the foregoing (i−1)^{th} layer of representation vector may be understood as Gᵢ₋₁. The foregoing (i−k)^{th} intermediate layer of representation parameter may be understood as Hᵢ₋ₖ. The foregoing (i−k)^{th} layer of representation vector may be understood as Gᵢ₋ₖ.

As shown in FIG. 7, Gᵢ₋₁ outputted by a “Multi-Head Attention” module is superimposed with Hᵢ₋ₖ of the (i−k)^{th} layer of attention module which is processed by a “Layer Norm” module and a “Feed Forward” module to obtain Hᵢ₋₁.

As a solution, the processing the target media resource feature by using N layers of attention modules to obtain a target representation vector includes:
performing, in a case that the at least two layers of attention modules are M layers of attention modules, and M is less than N, the following operations for a p^{th} layer of attention module other than the M layers of attention modules among the N layers of attention modules:
determining, based on a pre-configured shared relationship, a j^{th} layer of representation vector outputted by a j^{th} layer of attention module among the M layers of attention modules as a p^{th} layer of representation vector outputted by the p^{th} layer of attention module, the shared relationship being used for indicating that the j^{th} layer of representation vector outputted by the j^{th} layer of attention module is shared with the p^{th} layer of attention module.

In this embodiment, the foregoing M layers of attention modules may be pre-configured, so that the p^{th} layer of attention module other than the M layers of attention modules among the N layers of attention modules determines, based on the pre-configured shared relationship, the j^{th} layer of representation vector outputted by the j^{th} layer of attention module among the M layers of attention modules as the p^{th} layer of representation vector outputted by the p^{th} layer of attention module.

In other words, because the attention weight parameter is not shared, but the to-be-learned parameters for calculating the attention weight parameter are shared, the amount of calculation increases. In this case, neighboring attention modules share the same calculation result to reduce a quantity of parameters. In addition, different layers of self-attention weights are different as needed, so that performance is not lower than or even better than that of directly sharing of attention models of self-attention weights.

As a solution, for the i^{th} layer of attention module, the processing the target media resource feature by using N layers of attention modules to obtain a target representation vector includes:

determining, in a case that the i^{th} layer of attention module is a T-head attention module, and T is a positive integer greater than or equal to 2, T i^{th} layer of initial representation vectors respectively based on a T-subgroup of shared parameters and the i^{th} group of non-shared parameters by using the T-head attention module, and performing weighted summation on the T i^{th} layer of initial representation vectors to obtain the i^{th} layer of representation vector outputted by the i^{th} layer of attention module, the group of shared parameters including the T-subgroup of shared parameters.

In this embodiment, the foregoing N layers of attention modules may all be T-head attention modules, or part of the N layers of attention modules may be T-head attention modules. The i^{th} layer of attention module is a T-head attention module, and each single-chip attention model is assigned a corresponding shared parameter to determine the T i^{th} layer of initial representation vectors based on T-subgroup of shared parameters and non-shared parameters. Further, weighted summation can be performed on the T i^{th} layer of initial representation vectors to obtain the i^{th} layer of representation vector outputted by the i^{th} layer of attention module.

This disclosure is further described in detail with reference to the following specific embodiment.

This disclosure may be used for automatic conference minutes in an online conference. As shown in FIG. 8, the self-attention unified calculation module has two forms. An encoder is used as an example (the same applies to the decoder):

(1) Layer-by-layer dependence mode, that is, in a case that the current layer of attention is calculated, the previous layer of result may be referred, so that the attention is more consistent and the training is more stable.

Specifically, a single-chip attention calculation manner in the multi-head attention module of the i^{th} layer of Transformer is:

$$\begin{matrix}{Q}_{i} = {H}_{i - 1} {W}^{Q} \\ {K}_{i} = {H}_{i - 1} {W}^{K} \\ {V}_{i} = {H}_{i - 1} {W}^{V} \\ {A}_{i} = Softmax ( {Q}_{i} {K}_{i}^{T} / \sqrt{{d}_{k}} ) \\ {A}_{i}^{′} = f ( {A}_{i} , {A}_{i - 1}^{′} ) \\ {G}_{i} = {A}_{i}^{′} {V}_{i}\end{matrix}$$

H in the foregoing formula represents input of the multi-head attention module (an intermediate layer of representation). W^{Q}, W^{K}, and W^{V} represent to-be-learned parameters and are in a matrix form. All Q, K, V, and A are intermediate calculation results. d_{K} represents a length of K. A′ᵢ is a self-attention value of an i^{th} layer of Transformer. ƒ is a user-defined function. G is result output of a self-attention module (still an intermediate layer of representation). Other single-chip attention calculation manners in the multi-head attention module are similar. Different layers of multi-head attention modules of Transformer in the encoder share W^{Q}, W^{K}, and W^{V}. The function ƒ refers to a previous layer of result in a case that a current layer of attention is calculated. A selection manner of ƒ is flexible, such as ƒ (Aᵢ, A′ᵢ₋₁)=(1−α)Aᵢ+αA′ᵢ₋₁, 0≤α≤1. In a case that α=1, ƒ is an attention weight value sharing mode. In a case that α=0, ƒ does not depend on a previous layer of self-attention weight. ƒ may be another neural network with any complexity.

Due to the increased amount of calculation, neighboring layers may share the same calculation result.

(2) Parallel computing mode at each layer. Specifically, a single-chip attention calculation manner in the multi-head attention module of the i^{th} layer of Transformer is:

$$\begin{matrix}{Q}_{i} = {XW}^{Q} \\ {K}_{i} = {XW}^{K} \\ {V}_{i} = {H}_{i - 1} {W}^{V} \\ {A}_{i} = Softmax ( {Q}_{i} {K}_{i}^{T} / \sqrt{{d}_{k}} ) \\ {A}_{i} = {f}_{i} ( A ) \\ {G}_{i} = {A}_{i} {G}_{i}\end{matrix}$$

H in the foregoing formula represents input of the multi-head attention module (an intermediate layer of representation). X represents input of the whole encoder (which usually is an original voice feature And performed by some simple layers of neural networks). W^{Q}, W^{K}, and W^{V} represent to-be-learned parameters and are in a matrix form. All Q, K, V, and A are intermediate calculation results. d_{K} represents a length of K. Aᵢ is a self-attention value of an i^{th} layer of Transformer. ƒ is a user-defined function. ƒ of each layer of Transformer is independent of each other. G is result output of a self-attention module (still an intermediate layer of representation). Other single-chip attention calculation manners in the multi-head attention module are similar. Different layers of multi-head attention modules of Transformer in the encoder share Q, K, and V. A function ƒ allows different layers to obtain different final attention weights Aᵢ based on the same initial attention value A. A selection manner of ƒ is flexible, such as ƒᵢ(A)=A+Wᵢ, or may be another neural network with any complexity.

For a Conformer/Transformer structure-based end-to-end voice recognition system, a main factor affecting calculation efficiency of the system is calculation of a layer-by-layer self-attention mechanism. Each layer of parallel computing mode in this disclosure may calculate another layer of all attention weights in a case that original input is obtained, to greatly improve calculation efficiency.

A model structure provided in this disclosure is better than a conventional model structure on a plurality of voice data sets, and has fewer model parameters, especially on small data sets. Each layer of parallel computing model in this disclosure greatly improves calculation efficiency.

The model structure provided in this disclosure has faster convergence speed than the conventional model structure.

It may be understood that in the specific implementation of this disclosure, relevant data such as user information is involved. In a case that the foregoing embodiments of this disclosure are applied to a specific product or technology, a permission or consent of a user is required, and collection, use, and processing of the relevant data need to comply with relevant laws, regulations, and standards of relevant countries and regions.

For each of the foregoing method embodiments, for ease of description, the method embodiment is described as a series of action combination. But a person skilled in the art is to learn that this disclosure is not limited to any described sequence of the action, because according to this disclosure, some steps may use other sequences or may be executed at the same time. In addition, a person skilled in the art also knows that all the embodiments described in the specification are exemplary embodiments, and the related actions and modules are not necessarily required by this disclosure.

According to another embodiment of this disclosure, an attention module-based information recognition apparatus for performing the attention module-based information recognition method is further provided. As shown in FIG. 9, the apparatus includes:
an obtaining module 902, configured to obtain a target media resource feature of a target media resource, and input the target media resource feature into a target information recognition model, the target information recognition model including N layers of attention modules, and N being a positive integer greater than or equal to 2;
a processing module 904, configured to process the target media resource feature by using the N layers of attention modules to obtain a target representation vector, an i^{th} layer of attention module among the N layers of attention modules being configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module; 1≤i≤N, in a case that i is less than N, the i^{th} layer of representation vector being used for determining an (i+1)^{th} group of non-shared parameters used by an (i+1)^{th} layer of attention module, and in a case that i is equal to N, the i^{th} layer of representation vector being used for determining the target representation vector; at least two layers of attention modules among the N layers of attention modules sharing the group of shared parameters; and the at least two layers of attention modules including the i^{th} layer of attention module; and
a determining module 906, configured to determine a target information recognition result based on the target representation vector, the target information recognition result being used for representing target information recognized from the target media resource.

As a solution, the processing module 904 is further configured to:
determine the i^{th} layer of attention weight parameter based on a first part of shared parameters and an (i−1)^{th} intermediate layer of representation parameter, the group of shared parameters including the first part of shared parameters and a second part of shared parameters, and the (i−1)^{th} intermediate layer of representation parameter being an intermediate layer of representation parameter determined based on an (i−1)^{th} layer of representation vector outputted by an (i−1)^{th} layer of attention module; and
determine the i^{th} layer of input representation vector based on the second part of shared parameters and the (i−1)^{th} intermediate layer of representation parameter, the i^{th} group of non-shared parameters including the (i−1)^{th} intermediate layer of representation parameter.

As a solution, the processing module 904 is further configured to:
separately multiply, in a case that the first part of shared parameters includes a first shared parameter W^{Q} and a second shared parameter W^{K}, and the (i−1)^{th} intermediate layer of representation parameter is Hᵢ₋₁, Hᵢ₋₁ by W^{Q} and W^{K} to obtain a first correlation parameter Qᵢ and a second correlation parameter Kᵢ used in the i^{th} layer of attention module;
perform normalization processing on the first correlation parameter Qᵢ and
the second correlation parameter Kᵢ to obtain an initial attention weight parameter Aᵢ of the i^{th} layer of attention module; and
determine the i^{th} layer of attention weight parameter based on the initial attention weight parameter Aᵢ and an (i−1)^{th} layer of attention weight parameter A′ᵢ₋₁ that is used in the (i−1)^{th} layer of attention module.

As a solution, the processing module 904 is further configured to:
perform weighted summation on the initial attention weight parameter Aᵢ and the (i−1)^{th} layer of attention weight parameter A′ᵢ₋₁ to obtain the i^{th} layer of attention weight parameter.

As a solution, the processing module 904 is further configured to: determine, in a case that the at least two layers of attention modules further include the (i+1)^{th} layer of attention module, the (i+1)^{th} layer of attention weight parameter based on the first part of shared parameters and an i^{th} intermediate layer of representation parameter, the i^{th} intermediate layer of representation parameter being an intermediate layer of representation parameter determined based on the i^{th} layer of representation vector outputted by the i^{th} layer of attention module; and
determine the (i+1)^{th} layer of input representation vector based on the second part of shared parameters and the i^{th} intermediate layer of representation parameter, the (i+1)^{th} group of non-shared parameters including the i^{th} intermediate layer of representation parameter.

As a solution, the processing module 904 is further configured to:
determine the i^{th} layer of attention weight parameter based on a shared
attention weight parameter and a weighting parameter that is used in the i^{th} layer of attention module, the group of shared parameters including the shared attention weight parameter and a second part of shared parameters; and
determine the i^{th} layer of input representation vector based on the second part of shared parameters and an (i−1)^{th} intermediate layer of representation parameter, the (i−1)^{th} intermediate layer of representation parameter being an intermediate layer of representation parameter determined based on an (i−1)^{th} layer of representation vector outputted by an (i−1)^{th} layer of attention module, and the i^{th} group of non-shared parameters including the (i−1)^{th} intermediate layer of representation parameter.

As a solution, the processing module 904 is further configured to:
determine a sum of the shared attention weight parameter and the weighting parameter that is used in the i^{th} layer of attention module as the i^{th} layer of attention weight parameter.

As a solution, the processing module 904 is further configured to:
obtain an initial representation feature of the target media resource, the initial representation feature being the target media resource feature, or a feature converted based on the target media resource feature;
separately multiply, in a case that the group of shared parameters further includes a first part of shared parameters, and the first part of shared parameters includes a first shared parameter W^{Q} and a second shared parameter W^{K}, the initial representation feature by W^{Q} and W^{K} to obtain a first shared correlation parameter Q and a second shared correlation parameter K; and
perform normalization processing on the first shared correlation parameter Q and the second shared correlation parameter K to obtain the shared attention weight parameter.

As a solution, the processing module 904 is further configured to: determine, in a case that the at least two layers of attention modules further include the (i+1)^{th} layer of attention module, an (i+1)^{th} layer of attention weight parameter based on the shared attention weight parameter and a weighting parameter that is used in the (i+1)^{th} layer of attention module; and
determine the (i+1)^{th} layer of input representation vector based on the second part of shared parameters and an i^{th} intermediate layer of representation parameter, the i^{th} intermediate layer of representation parameter being an intermediate layer of representation parameter determined based on the i^{th} layer of representation vector outputted by the i^{th} layer of attention module, and the (i+1)^{th} group of non-shared parameters including the i^{th} intermediate layer of representation parameter.

As a solution, the processing module 904 is further configured to:
multiply, in a case that the second part of shared parameters includes a third shared parameter W^{V}, and the (i−1)^{th} intermediate layer of representation parameter is Hᵢ₋₁, Hᵢ₋₁ by W^{V} to obtain the i^{th} layer of input representation vector.

As a solution, the processing module 904 is further configured to:
obtain an (i−k)^{th} intermediate layer of representation parameter in a case that the (i−1)^{th} layer of representation vector outputted by the (i−1)^{th} layer of attention module is obtained, 1<k<i, and the (i−k)^{th} intermediate layer of representation parameter being an intermediate layer of representation parameter determined based on an (i−k)^{th} layer of representation vector outputted by the (i−k)^{th} layer of attention module; and
determine the (i−1)^{th} intermediate layer of representation parameter based on the (i−1)^{th} layer of representation vector and the (i−k)^{th} intermediate layer of representation parameter.

As a solution, the processing module 904 is further configured to:
perform, in a case that the at least two layers of attention modules are M layers of attention modules, and M is less than N, the following operations for a p^{th} layer of attention module other than the M layers of attention module among the N layers of attention modules:
determine, based on a pre-configured shared relationship, a j^{th} layer of representation vector outputted by a j^{th} layer of attention module among the M layers of attention modules as a p^{th} layer of representation vector outputted by the p^{th} layer of attention module, the shared relationship being used for indicating that the j^{th} layer of representation vector outputted by the j^{th} layer of attention module is shared with the p^{th} layer of attention module.

As a solution, the processing module 904 is further configured to:
determine, in a case that the i^{th} layer of attention module is a T-head attention module, and T is a positive integer greater than or equal to 2, T i^{th} layer of initial representation vectors respectively based on a T-subgroup of shared parameters and the i^{th} group of non-shared parameters by using the T-head attention module, and perform weighted summation on the T i^{th} layer of initial representation vectors to obtain the i^{th} layer of representation vector outputted by the i^{th} layer of attention module, the group of shared parameters including the T-subgroup of shared parameters.

According to an aspect in this disclosure, a computer program product is provided. The computer program product includes a computer program/instruction. The computer program/instruction includes program code used for performing the method shown in the flowchart. In such an embodiment, the computer program may be downloaded and installed from a network by using a communication part 1009, and/or installed from a removable medium 1011. When the computer program is executed by a central processing unit 1001, various functions provided in the embodiment of this disclosure are performed.

The sequence numbers of the foregoing embodiments of this disclosure are merely for description purpose but do not imply the preference among the embodiments.

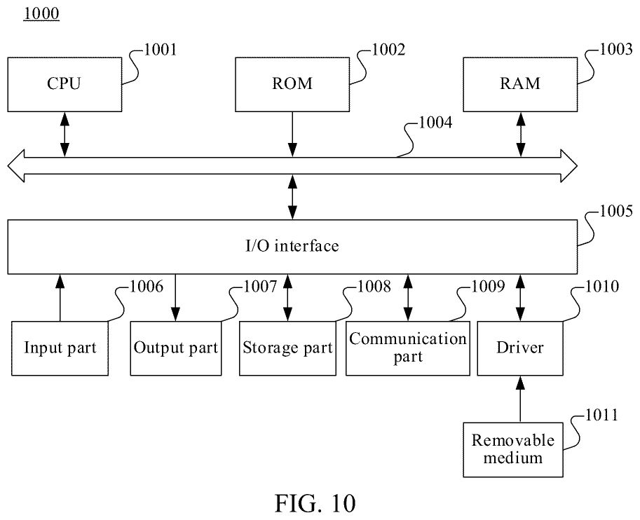

FIG. 10 is a schematic block diagram of a structure of a computer system for an electronic device for implementing an embodiment of this disclosure.

The computer system 1000 of the electronic device shown in FIG. 10 is merely an example, and does not constitute any limitation on functions and use ranges of the embodiments of this disclosure.

As shown in FIG. 10, the computer system 1000 includes a central processing unit (CPU) 1001, which may execute various proper actions and processing based on a program stored in a read-only memory (ROM) 1002 or a program loaded from a storage part 1008 into a random access memory (RAM) 1003. The random access memory 1003 further stores various programs and data required by system operations. The central processing unit 1001, the read-only memory 1002, and the random access memory 1003 are connected to each other through a bus 1004. An input/output interface (that is an I/O interface) 1005 is also connected to the bus 1004.

The following components are connected to the input/output interface 1005: an input part 1006 including a keyboard, a mouse, and the like, an output part 1007 including a cathode ray tube (CRT), a liquid crystal display (LCD), a speaker, and the like, a storage part 1008 including a hard disk, and the like, and a communication part 1009 including a network interface card such as a local area network card, and a modem. The communication part 1009 performs communication processing by using a network such as the Internet. A driver 1100 is also connected to the input/output interface 1005 as needed. A removable medium 1011, such as a magnetic disk, an optical disc, a photomagnetic disk, and a semiconductor memory, is installed on the drive 1100 as needed, so that a computer program read from the removable medium is installed into the storage part 1008 as needed.

Particularly, according to an embodiment of this disclosure, the processes described in each method flowchart may be implemented as a computer software program. For example, the embodiment of this disclosure includes a computer program product. The computer program product includes a computer program carried on a computer-readable medium, and the computer program includes program code used for performing the methods shown in the flowcharts. In such an embodiment, the computer program may be downloaded and installed from a network by using a communication part 1009, and/or installed from a removable medium 1011. When the computer program is executed by the central processing unit 1001, various functions defined in the system of this disclosure are performed.

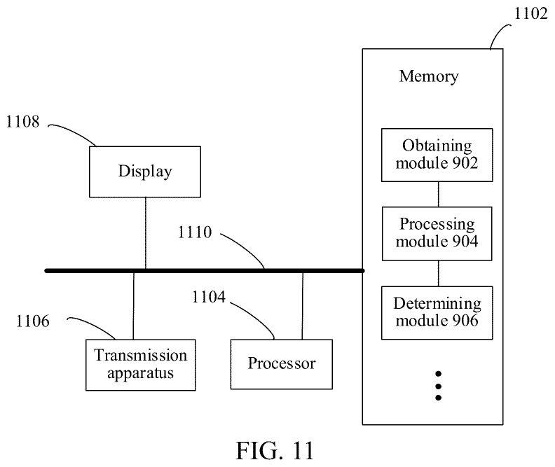

According to another aspect in embodiments of this disclosure, an electronic device for implementing the foregoing attention module-based information recognition method is further provided. The electronic device may be the terminal device or the server as shown in FIG. 1. In this embodiment, an example in which the electronic device is the terminal device is used for description. As shown in FIG. 11, the electronic device includes a memory 1102 and a processor 1104 (e.g., processing circuitry). The memory 1102 has a computer program stored therein, and the processor 1104 is configured to perform steps in any of the foregoing method embodiments by a computer program.

In this embodiment, the foregoing electronic device may be located in at least one of a plurality of network devices in a computer network.

In this embodiment, the processor may be configured to execute the computer program to perform the following steps.

S1: Obtain a target media resource feature of a target media resource, and input the target media resource feature into a target information recognition model, the target information recognition model including N layers of attention modules, and N being a positive integer greater than or equal to 2.

S2: Process the target media resource feature by using the N layers of attention modules to obtain a target representation vector, an i^{th} layer of attention module among the N layers of attention modules being configured to determine an i^{th} layer of attention weight parameter and an i^{th} layer of input representation vector based on a group of shared parameters and an i^{th} group of non-shared parameters, and determine, based on the i^{th} layer of attention weight parameter and the i^{th} layer of input representation vector, an i^{th} layer of representation vector outputted by the i^{th} layer of attention module; 1≤i≤N, in a case that i is less than N, the i^{th} layer of representation vector being used for determining an (i+1)^{th} group of non-shared parameters used by an (i+1)^{th} layer of attention module, and in a case that i is equal to N, the i^{th} layer of representation vector being used for determining the target representation vector; at least two layers of attention modules among the N layers of attention modules sharing the group of shared parameters; and the at least two layers of attention modules including the i^{th} layer of attention module.

S3: Determine a target information recognition result based on the target representation vector, the target information recognition result being used for representing target information recognized from the target media resource.

In an embodiment, a person of ordinary skill in the art may understand that the structure shown in FIG. 11 is merely an example. The electronic device may alternatively be a terminal device such as a smartphone, a tablet computer, a palmtop computer, a mobile Internet device (MID), or a PAD.

The memory 1102 may be configured to store a software program and a module, such as a program instruction/module corresponding to the attention module-based information recognition method and apparatus in the embodiments of this disclosure. The processor 1104 runs the software program and the module stored in the memory 1102, to implement various functional applications and data processing, in other words, to implement the attention module-based information recognition method.

In an embodiment, a transmission apparatus 1106 is configured to receive or send data by using a network.

In addition, the electronic device further includes: a display 1108, configured to display the target information recognition result; and a connected bus 1110, configured to connect various module components in the foregoing electronic device.

In another embodiment, the foregoing terminal device or server may be a node in a distributed system. The distributed system may be a blockchain system, and the blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect in this disclosure, a non-transitory computer-readable storage medium is provided. A processor of a computer device reads computer instructions from the computer-readable storage medium. The processor executes the computer instructions, so that the computer device performs the attention module-based information recognition method provided in various implementations of the foregoing attention module-based information recognition aspect.

An embodiment of this disclosure further provides a computer program product including a computer program, the computer program product, when running on a computer, causing the computer to perform the method according to the foregoing embodiments.

In this embodiment, a person of ordinary skill in the art may understand that, all or some steps in the methods of the foregoing embodiments may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

The sequence numbers of the foregoing embodiments of this disclosure are merely for description purpose but do not imply the preference among the embodiments.

In a case that the integrated unit in the foregoing embodiments is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of steps of the method in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, it is to be understood that, the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by using some interfaces, units, or modules, and may be electrical or of other forms.

The units described as separate components may or may not be physically separated, and components displayed as units may or may not be physical units, may be located in one place, or may be distributed on a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely exemplary implementations of this disclosure. A person of ordinary skill in the art may further make various improvements and modifications without departing from the principle of this disclosure, and the improvements and modifications fall within the protection scope of this disclosure.

What is claimed is:

1. An attention module-based information recognition method, comprising:
inputting a media resource feature of a media resource into a target information recognition model, the target information recognition model comprising N layers of attention modules, N being a positive integer greater than or equal to 2;
processing the media resource feature by using the N layers of attention modules to obtain a representation vector, an i^{th} layer of attention module among the N layers of attention modules being configured to
determine an i^{th} layer of attention weight parameter and an i^{th} layer of input representation vector based on (i) a group of shared parameters and (ii) an i^{th} group of non-shared parameters, and
determine, based on the i^{th} layer of attention weight parameter and the i^{th} layer of input representation vector, an i^{th} layer of representation vector outputted by the i^{th} layer of attention module, wherein 1≤i≤N,
wherein when i is less than N, the i^{th} layer of representation vector determining an (i+1)^{th} group of non-shared parameters used by an (i+1)^{th} layer of attention module, and
wherein when i is equal to N, the i^{th} layer of representation vector determining the representation vector, wherein at least two layers of attention modules among the N layers of attention modules share the group of shared parameters, and
determining a target information recognition result based on the representation vector, the target information recognition result representing target information recognized in the media resource.

2. The method according to claim 1, wherein
the i^{th} layer of attention weight parameter and the i^{th} layer of input representation vector are determined by:
determining the i^{th} layer of attention weight parameter based on a first portion of the shared parameters and an (i−1)^{th} intermediate layer of representation parameter, and the (i−1)^{th} intermediate layer of representation parameter is an intermediate layer of representation parameter determined based on an (i−1)^{th} layer of representation vector outputted by an (i−1)^{th} layer of attention module; and
determining the i^{th} layer of input representation vector based on a second portion of the shared parameters and the (i−1)^{th} intermediate layer of representation parameter, the i^{th} group of non-shared parameters comprising the (i−1)^{th} intermediate layer of representation parameter.

3. The method according to claim 2, wherein the determining the i^{th} layer of attention weight parameter based on the first portion of the shared parameters and the (i−1)^{th} intermediate layer of representation parameter comprises:
when the first portion of the shared parameters comprises a first shared parameter W^{Q} and a second shared parameter W^{K}, and the (i−1)^{th} intermediate layer of representation parameter is Hᵢ₋₁, separately multiplying Hᵢ₋₁ by W^{Q} and W^{K} to obtain a first correlation parameter Qᵢ and a second correlation parameter Kᵢ used in the i^{th} layer of attention module;
performing normalization processing on the first correlation parameter Qᵢ and the second correlation parameter Kᵢ to obtain an initial attention weight parameter A′ⁱ⁻¹ of the i^{th} layer of attention module; and
determining the i^{th} layer of attention weight parameter based on the initial attention weight parameter Aᵢ and an (i−1)^{th} layer of attention weight parameter A′ᵢ₋₁ from the (i−1)^{th} layer of attention module.

4. The method according to claim 3, wherein the determining the i^{th} layer of attention weight parameter based on the initial attention weight parameter Aᵢ and the (i−1)^{th} layer of attention weight parameter A′ᵢ₋₁ comprises:
performing weighted summation on the initial attention weight parameter Aᵢ and the (i−1)^{th} layer of attention weight parameter A′ᵢ₋₁ to obtain the i^{th} layer of attention weight parameter.

5. The method according to claim 2, wherein when the at least two layers of attention modules further comprise the (i+1)^{th} layer of attention module, an (i+1)^{th} layer of attention weight parameter and an (i+1)^{th} layer of input representation vector of the (i+1)^{th} layer of attention module are determined by:
determining the (i+1)^{th} layer of attention weight parameter based on the first portion of the shared parameters and an i^{th} intermediate layer of representation parameter determined based on the i^{th} layer of representation vector outputted by the i^{th} layer of attention module; and
determining the (i+1)^{th} layer of input representation vector based on the second portion of the shared parameters and the i^{th} intermediate layer of representation parameter, the (i+1)^{th} group of non-shared parameters comprising the i^{th} intermediate layer of representation parameter.

6. The method according to claim 1, wherein the i^{th} layer of attention weight parameter and the i^{th} layer of input representation vector are determined by:
determining the i^{th} layer of attention weight parameter based on a shared attention weight parameter from the group of shared parameters and a weighting parameter that is used in the i^{th} layer of attention module; and
determining the i^{th} layer of input representation vector based on a second portion of the shared parameters and an (i−1)^{th} intermediate layer of representation parameter determined based on an (i−1)^{th} layer of representation vector outputted by an (i−1)^{th} layer of attention module, and the i^{th} group of non-shared parameters comprising the (i−1)^{th} intermediate layer of representation parameter.

7. The method according to claim 6, wherein the determining the i^{th} layer of attention weight parameter based on the shared attention weight parameter and the weighting parameter t comprises:
determining a sum of the shared attention weight parameter and the weighting parameter that is used in the i^{th} layer of attention module as the i^{th} layer of attention weight parameter.

8. The method according to claim 6, further comprising:
obtaining an initial representation feature of the media resource, the initial representation feature being the media resource feature, or a feature converted based on the media resource feature;
when the group of shared parameters further comprises a first portion of the shared parameters including a first shared parameter W^{Q} and a second shared parameter W^{K}, separately multiplying the initial representation feature by W^{Q} and W^{K} to obtain a first shared correlation parameter Q and a second shared correlation parameter K; and
performing normalization processing on the first shared correlation parameter Q and the second shared correlation parameter K to obtain the shared attention weight parameter.

9. The method according to claim 6, wherein the processing the media resource feature by using the N layers of attention modules to obtain a representation vector comprises:
determining, when the at least two layers of attention modules further comprise the (i+1)^{th} layer of attention module, an (i+1)^{th} layer of attention weight parameter and an (i+1)^{th} layer of input representation vector of the (i+1)^{th} layer of attention module by:
determining an (i+1)^{th} layer of attention weight parameter based on the shared attention weight parameter and a weighting parameter used in the (i+1)^{th} layer of attention module; and
determining the (i+1)^{th} layer of input representation vector based on the second portion of the shared parameters and an i^{th} intermediate layer of representation parameter determined based on the i^{th} layer of representation vector outputted by the i^{th} layer of attention module, and the (i+1)^{th} group of non-shared parameters comprising the i^{th} intermediate layer of representation parameter.

10. The method according to claim 2, wherein the determining the i^{th} layer of input representation vector based on the second portion of the shared parameters and the (i−1)^{th} intermediate layer of representation parameter comprises:
when the second portion of the shared parameters comprises a third shared parameter W^{V}, and the (i−1)^{th} intermediate layer of representation parameter is Hᵢ₋₁, multiplying Hᵢ₋₁ by W^{V} to obtain the i^{th} layer of input representation vector.

11. The method according to claim 2, further comprising:
obtaining an (i−k)^{th} intermediate layer of representation parameter when the (i−1)^{th} layer of representation vector outputted by the (i−1)^{th} layer of attention module is obtained, 1<k<i, and the (i−k)^{th} intermediate layer of representation parameter being an intermediate layer of representation parameter determined based on an (i−k)^{th} layer of representation vector outputted by the (i−k)^{th} layer of attention module; and
determining the (i−1)^{th} intermediate layer of representation parameter based on the (i−1)^{th} layer of representation vector and the (i−k)^{th} intermediate layer of representation parameter.

12. The method according to claim 1, wherein the processing the media resource feature by using the N layers of attention modules to obtain the representation vector comprises:
performing, when the at least two layers of attention modules are M layers of attention modules, and M is less than N, for a p^{th} layer of attention module other than the M layers of attention modules among the N layers of attention modules:
determining, based on a pre-configured shared relationship, a j^{th} layer of representation vector outputted by a j^{th} layer of attention module among the M layers of attention modules as a p^{th} layer of representation vector outputted by the p^{th} layer of attention module, the shared relationship indicating that the j^{th} layer of representation vector outputted by the j^{th} layer of attention module is shared with the p^{th} layer of attention module.

13. The method according to claim 1, wherein for the i^{th} layer of attention module, the processing the media resource feature by using the N layers of attention modules to obtain the representation vector comprises:
determining, when the i^{th} layer of attention module is a T-head attention module, and T is a positive integer greater than or equal to 2, T i^{th} layer of initial representation vectors respectively based on a T-subgroup of shared parameters and the i^{th} group of non-shared parameters by using the T-head attention module, and performing weighted summation on the T i^{th} layer of initial representation vectors to obtain the i^{th} layer of representation vector outputted by the i^{th} layer of attention module, the group of shared parameters comprising the T-subgroup of shared parameters.

14. An attention module-based information recognition apparatus, comprising:
processing circuitry configured to input a media resource feature of a media resource into a target information recognition model, the target information recognition model comprising N layers of attention modules, N being a positive integer greater than or equal to 2;
process the media resource feature by using the N layers of attention modules to obtain a representation vector, an i^{th} layer of attention module among the N layers of attention modules being configured to determine an i^{th} layer of attention weight parameter and an i^{th} layer of input representation vector based on (i) a group of shared parameters and (ii) an i^{th} group of non-shared parameters, and
determine, based on the i^{th} layer of attention weight parameter and the i^{th} layer of input representation vector, an i^{th} layer of representation vector outputted by the i^{th} layer of attention module, wherein 1≤i≤N,
wherein when i is less than N, the i^{th} layer of representation vector determining an (i+1)^{th} group of non-shared parameters used by an (i+1)^{th} layer of attention module, and
wherein when i is equal to N, the i^{th} layer of representation vector determining the representation vector, wherein at least two layers of attention modules among the N layers of attention modules share the group of shared parameters, and
determine a target information recognition result based on the representation vector, the target information recognition result representing target information recognized in the media resource.

15. The apparatus according to claim 14, wherein
the i^{th} layer of attention weight parameter and the i^{th} layer of input representation vector are determined by:
determining the i^{th} layer of attention weight parameter based on a first portion of the shared parameters and an (i−1)^{th} intermediate layer of representation parameter, and the (i−1)^{th} intermediate layer of representation parameter is an intermediate layer of representation parameter determined based on an (i−1)^{th} layer of representation vector outputted by an (i−1)^{th} layer of attention module; and
determining the i^{th} layer of input representation vector based on a second portion of the shared parameters and the (i−1)^{th} intermediate layer of representation parameter, the i^{th} group of non-shared parameters comprising the (i−1)^{th} intermediate layer of representation parameter.

16. The apparatus according to claim 15, wherein the processing circuitry is further configured to:
when the first portion of the shared parameters comprises a first shared parameter W^{Q} and a second shared parameter W^{K}, and the (i−1)^{th} intermediate layer of representation parameter is Hᵢ₋₁, separately multiply Hᵢ₋₁ by W^{Q} and W^{K} to obtain a first correlation parameter Qᵢ and a second correlation parameter Kᵢ used in the i^{th} layer of attention module;
perform normalization processing on the first correlation parameter Qᵢ and the second correlation parameter Kᵢ to obtain an initial attention weight parameter Aᵢ of the i^{th} layer of attention module; and
determine the i^{th} layer of attention weight parameter based on the initial attention weight parameter Aᵢ and an (i−1)^{th} layer of attention weight parameter A′ᵢ₋₁ from the (i−1)^{th} layer of attention module.

17. The apparatus according to claim 16, wherein the processing circuitry is further configured to:
perform weighted summation on the initial attention weight parameter Aᵢ and the (i−1)^{th} layer of attention weight parameter A′ᵢ₋₁ to obtain the i^{th} layer of attention weight parameter.

18. The apparatus according to claim 15, wherein when the at least two layers of attention modules further comprise the (i+1)^{th} layer of attention module, an (i+1)^{th} layer of attention weight parameter and an (i+1)^{th} layer of input representation vector of the (i+1)^{th} layer of attention module are determined by:
determining the (i+1)^{th} layer of attention weight parameter based on the first portion of the shared parameters and an i^{th} intermediate layer of representation parameter determined based on the i^{th} layer of representation vector outputted by the i^{th} layer of attention module; and
determining the (i+1)^{th} layer of input representation vector based on the second portion of the shared parameters and the i^{th} intermediate layer of representation parameter, the (i+1)^{th} group of non-shared parameters comprising the i^{th} intermediate layer of representation parameter.

19. The apparatus according to claim 14, wherein the i^{th} layer of attention weight parameter and the i^{th} layer of input representation vector are determined by:
determining the i^{th} layer of attention weight parameter based on a shared attention weight parameter from the group of shared parameters and a weighting parameter that is used in the i^{th} layer of attention module; and
determining the i^{th} layer of input representation vector based on a second portion of the shared parameters and an (i−1)^{th} intermediate layer of representation parameter determined based on an (i−1)^{th} layer of representation vector outputted by an (i−1)^{th} layer of attention module, and the i^{th} group of non-shared parameters comprising the (i−1)^{th} intermediate layer of representation parameter.

20. A non-transitory computer-readable storage medium storing computer-readable instructions thereon, which, when executed by processing circuitry, cause the processing circuitry to perform an attention module-based information recognition method comprising:
inputting a media resource feature of a media resource into a target information recognition model, the target information recognition model comprising N layers of attention modules, N being a positive integer greater than or equal to 2;
processing the media resource feature by using the N layers of attention modules to obtain a representation vector, an i^{th} layer of attention module among the N layers of attention modules being configured to
determine an i^{th} layer of attention weight parameter and an i^{th} layer of input representation vector based on (i) a group of shared parameters and (ii) an i^{th} group of non-shared parameters, and
determine, based on the i^{th} layer of attention weight parameter and the i^{th} layer of input representation vector, an i^{th} layer of representation vector outputted by the i^{th} layer of attention module, wherein 1≤i≤N,
wherein when i is less than N, the i^{th} layer of representation vector determining an (i+1)^{th} group of non-shared parameters used by an (i+1)^{th} layer of attention module, and
wherein when i is equal to N, the i^{th} layer of representation vector determining the representation vector, wherein at least two layers of attention modules among the N layers of attention modules share the group of shared parameters, and
determining a target information recognition result based on the representation vector, the target information recognition result representing target information recognized in the media resource.
